(19) United States
(12) Patent Application Publication
(10) Pub. No.: US 2025/0053675 A1
(43) Pub. Date: Feb. 13, 2025

(54) DATABASE-BASED DATA PROCESSING METHOD AND DEVICE

(71) Applicant: Beijing Volcano Engine Technology Co., Ltd., Beijing (CN)

(72) Inventor: Xinying YANG, Los Angeles, CA (US)

(21) Appl. No.: 18/784,151

(22) Filed: Jul. 25, 2024

(30) Foreign Application Priority Data
Aug. 7, 2023 (CN) 202310987794.4

(51) Int. Cl. G06F 21/62; G06F 21/60

(52) U.S. Cl. CPC G06F 21/6218; G06F 21/602; G06F 21/604; G06F 2221/2141

(57) ABSTRACT

The present disclosure provides a database-based data processing method, apparatus, computer device and storage medium. The method includes receiving a data processing request to a database; when the designated data is secret state data, querying an authorization information table in the database based on the user identification of the accessing party to detect whether the accessing party is an authorized user of the designated data; when the accessing party is an authorized user of the designated data, decrypting the designated data based on a key of the data party in an isolated security environment and executing the data processing instruction based on decrypted data to obtain the target data, and encrypting the target data based on a key of the accessing party to obtain a target data ciphertext; and returning a response message carrying the target data ciphertext in response to the data processing request.

### CROSS-REFERENCE TO RELATED APPLICATIONS

This application claims the priority to and benefits of the Chinese Patent Application No. 202310987794.4, filed on Aug. 7, 2023. The aforementioned patent application is hereby incorporated by reference in its entireties.

### TECHNICAL FIELD

The present disclosure relates to the field of computer technology, and in particular, to a database-based data processing method and apparatus.

### BACKGROUND

A cloud database refers to a database that is optimized or deployed into a virtual computing environment, with the ability to scale on demand, high availability, and storage integration. In order to satisfy the user's needs for data security, some cloud databases may directly store the ciphertext of the user's data, i.e., the secret state data, and when the user needs to query the data through the cloud database, the user's data is decrypted under a trusted execution environment, then queried using the decrypted data, and the queried data is encrypted and fed back to the user through the cloud database. Data processing in a trusted execution environment does not leak to the outside environment, and the degree of security is relatively high.

However, in this manner, encryption keys of cloud database users cannot be shared with other users, which means that data cannot be shared between different users, and users can only process their own data and cannot use the data of other users.

### SUMMARY

Embodiments of the present disclosure provide at least a database-based data processing method and apparatus.

In a first aspect, an embodiment of the present disclosure provides a database-based data processing method, including:
receiving a data processing request to a database, wherein the data processing request carries a user identification of an accessing party and a data processing instruction for indicating a processing of designated data to obtain target data;
when the designated data is secret state data, querying an authorization information table in the database based on the user identification of the accessing party to detect whether the accessing party is an authorized user of the designated data, wherein the secret state data refers to data stored by the database in decrypted form, and the authorization information table is used for recording authorized user information of the secret state data configured by a data party;
when the accessing party is an authorized user of the designated data, decrypting the designated data based on a key of the data party in an isolated security environment and executing the data processing instruction based on decrypted data to obtain the target data, and encrypting the target data based on a key of the accessing party to obtain a target data ciphertext; and
returning a response message carrying the target data ciphertext in response to the data processing request.

In an alternative implementation, the method further includes:
receiving an authorization configuration instruction sent by the data party, wherein the authorization configuration instruction carries a user identification of the data party, a data identification of the designated data, and user identifications of authorized users, and the authorization configuration instruction is used to instruct configuring that the authorized users are authorized to access to the designated data; and
recording a correspondence of the user identification of the data party, the data identification of the designated data, and the user identifications of the authorized users in the authorization information table in response to the authorization configuration instruction.

In an alternative implementation, the authorization configuration instruction further includes: an authorization access time limit, and the authorization information table records the correspondence of the user identification of the data party, the data identification of the designated data, and the user identifications of the authorized users and corresponding authorized access time limit, wherein the authorized access time limit is used to limit access time of the authorized users to the designated data.

In an alternative implementation, the method further includes:
receiving an authorization deletion instruction sent by the data party, wherein the authorization deletion instruction carries a user identification of the data party, a data identification of the designated data, and user identifications of authorized users, and wherein the authorization deletion instruction is used to instruct deletion of configuration information that the authorized users are authorized to access to the designated data; and
deleting a correspondence of the user identification of the data party, the data identification of the designated data, and the user identifications of the authorized users in the authorization information table in response to the authorization deletion instruction.

In an alternative implementation, designated data of the data party in the authorization information table is configured with user identifications of a plurality of authorized users.

In an alternative implementation, the authorization information table is dynamically updated with authorization configuration instructions sent by the data party.

In an alternative implementation, the designated data includes at least one column of secret state data in at least one data table corresponding to a designated column identification; or

the designated data includes at least one row of secret state data in at least one data table corresponding to a designated row identification; or

the designated data includes at least one secret state data element in at least one data table corresponding to a designated column identification and a designated row identification.

In an alternative implementation, the database is deployed in a trusted execution environment.

In an alternative implementation, the database is deployed in a trusted execution environment based on trusted hardware.

In an alternative implementation, the data processing instruction is used to instruct the processing of the designated data to obtain the target data, wherein the designated data includes first designated data of the accessing party and second designated data of the data party, and the first designated data and the second designated data are both secret state data;

the target data ciphertext is obtained by:
querying the authorization information table in the database based on the user identification of the accessing party, and detecting whether the accessing party is an authorized user of the second designated data; when the accessing party is an authorized user of the second designated data, decrypting the second designated data in the isolated security environment based on the key of the data party to obtain second decrypted data, and decrypting the first designated data based on the key of the accessing party to obtain first decrypted data; executing the data processing instruction based on the first decrypted data and the second decrypted data to obtain the target data, and encrypting the target data based on the key of the accessing party to obtain the target data ciphertext.

In a second aspect, an embodiment of the present disclosure provides a database-based data processing apparatus, including:
a receiving module, configured to receive a data processing request to a database, wherein the data processing request carries a user identification of an accessing party and a data processing instruction for indicating a processing of designated data to obtain target data;
a detection module, configured to, when the designated data is secret state data, query an authorization information table in the database based on the user identification of the accessing party to detect whether the accessing party is an authorized user of the designated data, wherein the secret state data refers to data stored by the database in decrypted form, and the authorization information table is used for recording authorized user information of the secret state data configured by a data party;
a processing module, configured to, when the accessing party is an authorized user of the designated data, decrypt the designated data based on a key of the data party in an isolated security environment and execute the data processing instruction based on decrypted data to obtain the target data, and encrypt the target data based on a key of the accessing party to obtain a target data ciphertext; and
a returning module, configured to return a response message carrying the target data ciphertext in response to the data processing request.

In an alternative implementation, the apparatus further includes a configuration module, configured to:
receive an authorization configuration instruction sent by the data party, wherein the authorization configuration instruction carries a user identification of the data party, a data identification of the designated data, and user identifications of authorized users, and the authorization configuration instruction is used to instruct configuring that the authorized users are authorized to access to the designated data; and
record a correspondence of the user identification of the data party, the data identification of the designated data, and the user identifications of the authorized users in the authorization information table in response to the authorization configuration instruction.

In an alternative implementation, the authorization configuration instruction further includes: an authorization access time limit, and the authorization information table records the correspondence of the user identification of the data party, the data identification of the designated data, and the user identifications of the authorized users and corresponding authorized access time limit, wherein the authorized access time limit is used to limit access time of the authorized users to the designated data.

In an alternative implementation, the apparatus further includes a deleting module, configured to:
receive an authorization deletion instruction sent by the data party, wherein the authorization deletion instruction carries a user identification of the data party, a data identification of the designated data, and user identifications of authorized users, and wherein the authorization deletion instruction is used to instruct deletion of configuration information that the authorized users are authorized to access to the designated data; and
delete a correspondence of the user identification of the data party, the data identification of the designated data, and the user identifications of the authorized users in the authorization information table in response to the authorization deletion instruction.

In an alternative implementation, designated data of the data party in the authorization information table is configured with user identifications of a plurality of authorized users.

In an alternative implementation, the authorization information table is dynamically updated with authorization configuration instructions sent by the data party.

In an alternative implementation, the designated data includes at least one column of secret state data in at least one data table corresponding to a designated column identification; or

the designated data includes at least one row of secret state data in at least one data table corresponding to a designated row identification; or

the designated data includes at least one secret state data element in at least one data table corresponding to a designated column identification and a designated row identification.

In an alternative implementation, the database is deployed in a trusted execution environment.

In an alternative implementation, the database is deployed in a trusted execution environment based on trusted hardware.

In an alternative implementation, the data processing instruction is used to instruct the processing of the designated data to obtain the target data, wherein the designated data includes first designated data of the accessing party and second designated data of the data party, and the first designated data and the second designated data are both secret state data;

wherein the apparatus is configured to:
query the authorization information table in the database based on the user identification of the accessing party, and detect whether the accessing party is an authorized user of the second designated data; when the accessing party is an authorized user of the second designated data, decrypt the second designated data in the isolated security environment based on the key of the data party to obtain second decrypted data, and decrypt the first designated data based on the key of the accessing party to obtain first decrypted data; execute the data processing instruction based on the first decrypted data and the second decrypted data to obtain the target data, and encrypt the target data based on the key of the accessing party to obtain the target data ciphertext.

In a third aspect, an embodiment of the present disclosure further provides a computer device including a processor and a non-transitory memory, wherein the memory is configured to store machine-readable instructions executable by the processor, the processor is configured to execute the machine-readable instructions stored in the memory, the machine-readable instructions, when executed by the processor, cause the processor to perform the steps of the database-based data processing method according to the first aspect or any implementation of the first aspect.

In a fourth aspect, an embodiment of the present disclosure further provides non-transitory computer-readable storage medium having a computer program stored thereon, wherein the computer program, when executed by a computer device, causes the computer device to perform the steps of the database-based data processing method according to the first aspect or any implementation of the first aspect.

It is to be understood that the foregoing general description and the following detailed description are exemplary and explanatory only and are not restrictive of the technical solutions of the present disclosure.

In order that the above objects, features and advantages of the present disclosure will be more readily apparent, the following detailed description of the embodiments of the present disclosure will be given with reference to the accompanying drawings.

### BRIEF DESCRIPTION OF DRAWINGS

In order to more clearly illustrate the technical solutions of the embodiments of the present disclosure, the accompanying drawings required for use in the embodiments, which are incorporated in and constitute a part of the specification, illustrate embodiments consistent with the present disclosure and, together with the description, serve to explain the technical solutions of the present disclosure, will be briefly described below. It is to be understood that the following drawings illustrate only certain embodiments of the present disclosure and are therefore not to be considered limiting in scope, and that other related drawings may be derived therefrom by one of ordinary skill in the art without inventive step.

FIG. 1 shows a schematic diagram of an application scenario according to embodiments of the disclosure;

FIG. 2 shows a flowchart of a database-based data processing method according to embodiments of the present disclosure;

FIG. 3 shows a schematic diagram of a database according to embodiments of the present disclosure;

FIG. 4 shows a schematic diagram of another database according to embodiments of the present disclosure;

FIG. 5 shows a schematic diagram of a database-based data processing apparatus according to embodiments of the present disclosure;

FIG. 6 shows a schematic diagram of a computer device according to embodiments of the present disclosure.

### DETAILED DESCRIPTION

To make the objects, technical solutions and advantages of the embodiments of the present disclosure clearer, the technical solutions in the embodiments of the present disclosure will be clearly and completely described below in conjunction with the accompanying drawings in the embodiments of the present disclosure, it is obvious that the described embodiments are only a part of the embodiments of the present disclosure, rather than all of the embodiments. The components of the embodiments of the present disclosure as generally described and illustrated herein could be arranged and designed in a wide variety of different configurations. Thus, the following detailed description of the embodiments of the disclosure is not intended to limit the scope of the disclosure, as claimed, but is merely representative of selected embodiments of the disclosure. Based on the embodiments of the present disclosure, all other embodiments obtained by those skilled in the art without making creative labor belong to the scope of protection of the present disclosure.

Through research, it has been found that in cloud database scenarios, in order to ensure the security of user data, the encryption key of the user is not shared with other users, and data sharing cannot be carried out among users. Users can only process their own data and cannot use the data of other users.

Based on the above research, the present disclosure provides a database-based data processing method and apparatus, which can use an authorization information table to determine whether an accessing party has the permission to use designated data when the designated data that needs to be used in a data processing request is encrypted. When the accessing party is an authorized user of the designated data, the designated data is decrypted using the data party's key in an isolated secure environment, and the decrypted data can be used for data processing to obtain the target data required by the accessing party. The encrypted target data is then encrypted and the encrypted target data ciphertext is returned, thus, data can be processed in a secure isolated security environment (or called isolated security area), and the designated data can be shared with the accessing party without leaking the data party's key.

The deficiencies of the solutions are all the results of the inventor's practice and careful study, and therefore, the discovery process of the above problems and the solutions provided by the present disclosure to the above problems hereinafter should be contributions made by the inventor to the present disclosure during the course of the present disclosure.

It should be noted that similar numerals and letters represent similar items in the following figures, and therefore, once an item is defined in one figure, it need not be further defined and explained in the following figures.

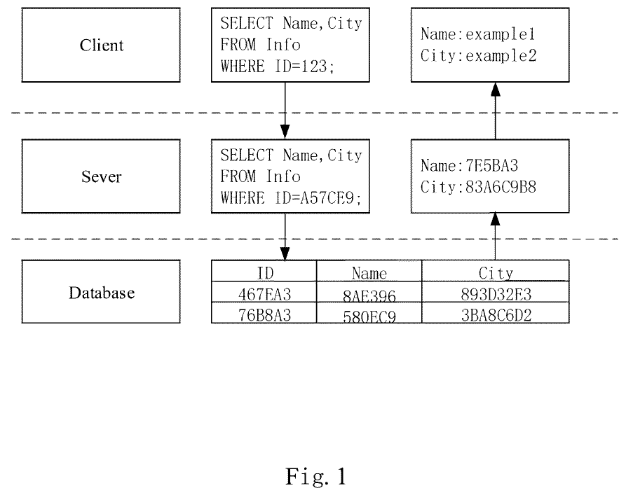

To facilitate understanding of the present disclosure, first, an introduction is made to an application scenario of the embodiments of the present disclosure. Referring to FIG. 1, a schematic diagram of an application scenario according to embodiments of the present disclosure is provided. The application scenario in FIG. 1 includes a client, a server, and a database. Typically, the user can enter query instructions on the client, such as:
SELECT NAME, City
FROM Info
WHERE ID=123;

The above query instruction may be interpreted as picking the Name column and the City column from a table Info, and filtering out the corresponding values from the table with ID “123” from the picked columns.

The client can encrypt the critical data “123” in the above query instruction with its own key data and send the encrypted query instruction to the server, then the query instruction received by the server may be:
SELECT Name, City
FROM Info
WHERE ID=A57CE9;

Among them, “A57CE9” is the encrypted data of the critical data “123”. In this application scenario, the client's key data is used to encrypt the above critical data “123” multiple times, and the encrypted data obtained each time can be different.

The server, after receiving the above-mentioned query instruction carrying encrypted data, may send the received query instruction to the database, which may have stored thereon data tables, for example, the above-mentioned table Info may be as shown in Table 1 below:

TABLE 1

| ID | Name | City |
|---|---|---|
| 467EA3 | 8AE396 | 893D32E3 |
| 76B8A3 | 580EC9 | 3BA8C6D2 |

The ID column, the Name column, and the City column are included in the above Table 1, and the data in each column may be encrypted data by the key data of the client.

The database, after receiving the instruction sent by the server, may decrypt the data in the table Info in the isolated secure environment, perform a data query using the decrypted data to find data matching the query instruction, and encrypt the queried data to generate a query result that is returned to the server. Illustratively, the query results returned above may be: Name: 7E5BA3, City: 83A6C9B8.

The returned query results are not identical to the data stored in Table 1 because they are encrypted using the client's key data. The server may return the query result in ciphertext to the client, which decrypts it with its own key data, resulting in the plaintext of the query result. Illustratively, the plain text of the above query result may be: Name: example 1, City: example 2.

Further, a database-based data processing method disclosed by the embodiments of the present disclosure will be described in detail, the execution body of the database-based data processing method provided by the embodiments of the present disclosure is generally a computer device having a certain computing power, such as a database. In some implementations, the database-based data processing method can be implemented by way of a processor invoking computer-readable instructions stored in a non-transitory memory.

The database-based data processing method provided by the embodiment of the present disclosure is described below by taking the execution body as a database as an example.

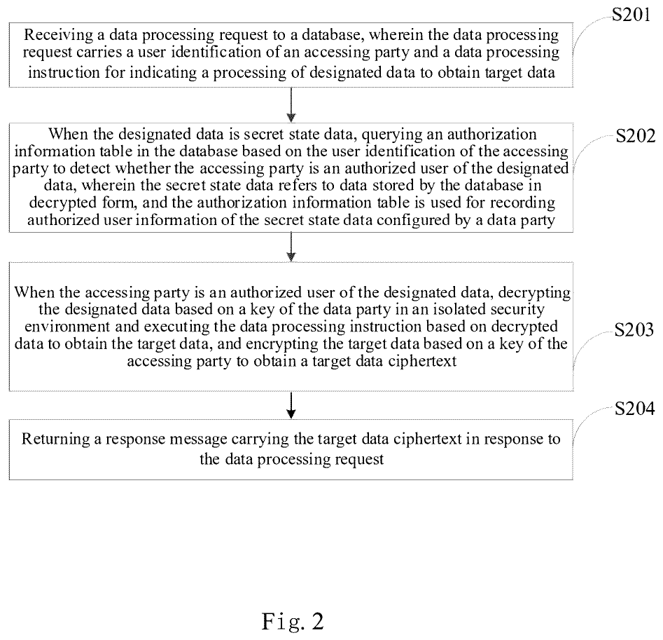

Referring to FIG. 2, it is a flowchart of a database-based data processing method provided by embodiments of the present disclosure. The method includes steps S201-S204, in which,

S201: Receiving a data processing request to a database, wherein the data processing request carries a user identification of an accessing party and a data processing instruction for indicating a processing of designated data to obtain target data.

The database may be a cloud database deployed in the cloud.

In this step, the database may receive a data processing request transmitted from the client, and the data processing request may carry a user identification of the accessing party and the data processing instruction is used for indicating a processing of designated data to obtain target data.

The data processing instruction may include relevant information indicating the designated data, and may indicate the location of the data to be queried, such as a data table to be queried, a particular column of data in the data table, constraints on the data in the column of data, and the like.

Illustratively, the data processing request may be represented in the form of a query statement. For instance, in the query statement “select t1.c1 from t1,t2 where t2.c1=t1.c1”, the meaning of the query statement can be interpreted as: look up the data in column c1 of table t1, and the data needs to be equal in value to the data in column c1 of table t2.

In the case where the “from” field in the query statement requires the use of the column c1 in the table t1 and the column c1 in the table t2, the designated data is the column c1 in the table t1 and the column c1 in the table t2. The designated data may be data from different data parties, for example, the data party of the column c1 of the table t1 may be a first client, the data party of the column c1 of the table t2 may be a second client, and the accessing party of the data may or may not be the data party of the designated data in whole or at least in part.

The data party may refer to the owner of the data, such as the client that created the data. The client may upload the required data to the database and operate on the data stored in the database by data processing requests. The types of operations may include a variety and may depend on the database schema employed by the database. Illustratively, the database may be a Structured Query Language database, and the query statements may use Structured Query Language (SQL).

To protect the security of user data, the database may store secret state data, that is, the data stored in the database is encrypted. The data fed back to the client is also encrypted. The database is unable to know the plaintext of the stored data. In this way, even if the data in the database is leaked, the leaked data is still confidential and relatively secure.

Further, the data in the database may employ isolated security environment (or called, isolated secure area) to respond to data processing requests. For example, the accessing party sends a data processing instruction to the database, if specific data is involved as a query, the data may be encrypted, and the database may decrypt the query using the corresponding key of the accessing party in the isolated security environment, decrypt the associated data stored in the database, perform the data processing in the isolated security environment, and encrypt the results of the query, and the database is unknown about the plaintext of the decrypted data in the trusted execution environment, and the results of the query are encrypted ciphertext, and the process of the data query may be more secure.

In the above encryption process, the same data is encrypted each time, and different ciphertext data results can be obtained, so that even if the ciphertext of the query result is available to the database, the ciphertext cannot be associated with the data stored in the database, further improving data security.

However, in the above data query mode, different keys need to be prepared for each user, and keys between users are not shared, so that data sharing between users cannot be performed.

To this end, embodiments of the present application maintain an authorization information table in the database to enable data sharing between users. For specific details, the description in the following steps can be referred.

S202, when the designated data is secret state data, querying an authorization information table in the database based on the user identification of the accessing party to detect whether the accessing party is an authorized user of the designated data, wherein the secret state data refers to data stored by the database in decrypted form, and the authorization information table is used for recording authorized user information of the secret state data configured by a data party.

In this step, when the designated data is secret state data, the authorization information table in the database may be queried based on the user identification of the accessing party, and the authorization information table may record information about authorized users configured by the data party for the secret state data, such as which users are authorized to access the secret state data.

For example, it may be determined whether the accessing party is an authorized user of the designated data by looking up an entry corresponding to the designated data from the authorization information table, and determining whether the user identification of the accessing party is recorded in the entry.

The authorization information table may be configured by the data party.

In an implementation, the database may query the authority information of the designated data from the authority information table, and the authority information may indicate the identification information of clients which correspond to the accessing authority and the identification information of clients which correspond to the control authority, in which, a client corresponding to the control authority may be the data party and a client corresponding to the accessing authority may be the client corresponding to the authorized user.

An exemplary authorization information table may be as shown in Table 2 below:

TABLE 2

| | USER | USER |
|---|---|---|
| | IDENTIFICATION | IDENTIFICATION |
| DATA | OF CONTROL | OF ACCESSING |
| IDENTIFICATION | AUTHORITY | AUTHORITY |
| 001 | 100012 | 100456 |
| 002 | 100013 | 100002 |

Wherein, the authorization information table may include a plurality of columns of data, each column of data including identification information indicating the data; identification information of clients having the accessing authority of the data column; and identification information having the control authority of the data column.

Compared to accessing authority, a client having control authority (i.e. data party) can perform more types of operations on data columns in the table. For example, if a first client has accessing authority, the first client can only read and not write data in a target data column, while a second client with control authority can either read or write data in a target data column.

The database may receive an authorization configuration instruction sent from a data party, the data party being able to share data for which the data party has control authority. The authorization configuration instruction may indicate a data identification of the designated data, a user identification of the data party, and a user identification of an authorized user, the database may specify a target entry corresponding to the data in the authorization configuration instruction, check the user identification of the data party, and update the user identification of the accessing authority in the target entry after the check is passed, and add the user identification of the authorized user to the authorization information table.

For example, if the target entry is found, the database can add the user identification of the authorized user mentioned above to the user identification with access authority in the target table entries, thereby completing the access authorization for shared authorized users. If the target entry is not found, the target entry for the designated data may be created in the authorization information table, and then, the user identification of the authorized user can be added to the created target entry.

The data party may also send an authorization deletion instruction, and the database may delete the user identification of the authorized user from the target entry based on the user identification of the data party, the data identification of the designated data, and the user identification of the authorized user carried by the authorization deletion instruction.

The above authorization information table may be configured with identifications of a plurality of authorized users for designated data of the data party, thereby enabling data sharing to a plurality of accessing parties.

The designated data may refer to one data column, one piece of data characters, one data file, or the like. In particular, the designated data may be at least one column of secret state data in at least one data table corresponding to a designated column identification, or may be at least one row of secret state data in at least one data table corresponding to a designated row identification, or may be at least one secret state data element in at least one data table corresponding to a designated column identification and a designated row identification.

In an implementation, a validity period may be set for the user identification of the authorized user in the above-described authorization information table, and the user identification may be deleted when the presence duration of the user identification is greater than the validity period.

Illustratively, the authorization configuration instruction may carry an authorization access time limit. Thus, the authorization information table may be specifically recorded with the correspondence of the user identification of the data party, the data identification of the designated data, and the user identifications of the authorized users and corresponding authorized access time limit. Wherein, the authorization access time limit is used to limit the access time of the authorized user to the designated data.

The authorization information table may be dynamically updated with authorization configuration instructions sent by the data party, thereby enabling changes to authorized users.

S203, When the accessing party is an authorized user of the designated data, decrypting the designated data based on a key of the data party in an isolated security environment and executing the data processing instruction based on decrypted data to obtain the target data, and encrypting the target data based on a key of the accessing party to obtain a target data ciphertext.

Upon determining that the accessing party possesses accessing authority to the designated data, the designated data may be decrypted in the isolated security environment using the key of the data party, for execution of data processing instruction in the isolated security environment, determination of target data, and encryption of the target data to obtain the target data ciphertext.

For example, if the client (data party) having the control authority of the designated data is a second client, thus, the data in the designated data is encrypted with a second key of the second client, and therefore, the isolated security environment needs to decrypt the designated data using the second key to obtain plaintext of the designated data, perform data processing based on the plaintext of the designated data, for executing the data processing instruction.

When the target data is obtained after processing, since the data processing request is sent by a first client (accessing party), and the first client does not itself hold the second key of the second client, thus, the target data can be encrypted using a first key of the first client to obtain the ciphertext of the target data, thereby enabling the first client can decrypt the encrypted target data to obtain the queried data.

Upon specifying the data processing instruction, the data query request is parsed and the data is processed according to the parsed flow. In one possible implementation, the data query request may be a query statement, and the query logic corresponding to the data query request may be obtained by parsing the query statement. According to query logic, the target data may be obtained by performing a query or the like from the plaintext of the designated data.

The above query statement typically contains some parameter information for performing a conditional query. The parameters of the conditional query may be parameters indicating the location of the data, the range of the data, and the parameter information needs to be encrypted for data security when a specific value of the data is concerned. Therefore, the processing may contain some encrypted data processing parameters.

Illustratively, in the query statement “select A where A=20”, where “20” is the data that needs to be encrypted.

The parameter information may be at least a portion of the designated data, which may be first designated data, and the secret state data stored in the database may be second designated data corresponding to the data party.

In this case, the target data ciphertext may be determined by:
querying the authorization information table in the database based on the user identification of the accessing party, and detecting whether the accessing party is an authorized user of the second designated data; when the accessing party is an authorized user of the second designated data, decrypting the second designated data in the isolated security environment based on the key of the data party to obtain second decrypted data, and decrypting the first designated data based on the key of the accessing party to obtain first decrypted data; executing the data processing instruction based on the first decrypted data and the second decrypted data to obtain the target data, and encrypting the target data based on the key of the accessing party to obtain the target data ciphertext.

Since the above-mentioned first designated data is indicated in the data processing request, that is, the data of the accessing party, it can be decrypted using the key of the accessing party.

If the accessing party does not have the query authority for the designated data (i.e., the accessing party is not an authorized user of the second designated data), it is possible to stop responding to the data processing request of the accessing party and to send a prompt to the accessing party that the query has failed.

The isolated security environment may be a trusted execution environment, in particular, the database may be deployed in a trusted execution environment, or the database may have a trusted execution environment deployed therein, which may be a trusted hardware-based trusted execution environment.

S204, returning a response message carrying the target data ciphertext in response to the data processing request.

After returning the target data ciphertext to the accessing party, the accessing party may decrypt the target data ciphertext using the key of the accessing party stored by itself to obtain the desired target data.

After the database returns the target data ciphertext to the accessing party, query notification information may also be sent to the data party indicating that the accessing party made access to the designated data, so as to provide a notification reminder to the data party.

The database-based data processing method provided by the embodiments of the present disclosure can use an authorization information table to determine whether an accessing party has the permission to use designated data when the designated data to be used in a data processing request is encrypted. When the accessing party is an authorized user of the designated data, the designated data can be decrypted using the key of the data owner in an isolated security environment, and the decrypted data can be used for data processing to obtain the target data required by the accessing party. The encrypted target data is then encrypted and the encrypted target data ciphertext is then returned, thus, data can be processed in a secure isolated security environment, and the designated data can be shared with the accessing party without leaking the key of the data party.

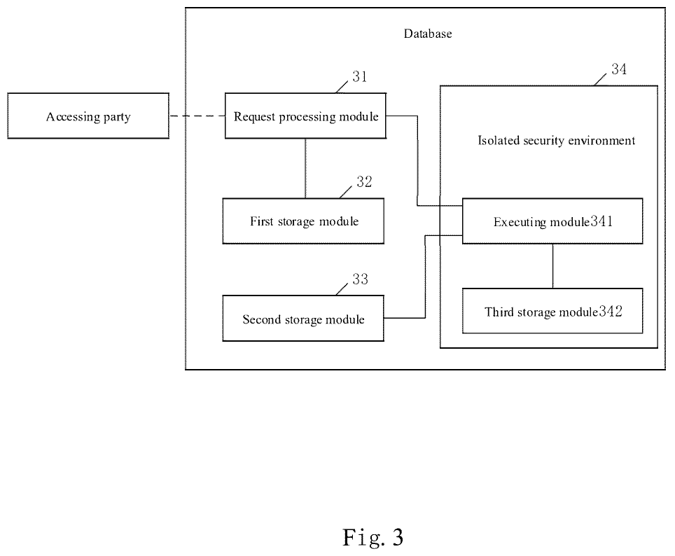

Referring to FIG. 3, a schematic diagram of a database according to embodiments of the present disclosure is shown. The database may include a request processing module 31, a first storage module 32, a second storage module 33, and an isolated security environment 34, which may include an execution module 341 and a third storage module 342. The request processing module 31 is configured to, upon receiving a data processing request of an accessing party, determine designated data corresponding to the data processing request and query from the first storage module 32 whether the accessing party has an accessing authority of the designated data, and upon possessing the accessing authority, send the data processing request to the isolated security environment 34, which may acquire the designated data from the second storage module 33 and acquire a key of the accessing party and a key of the data party from the third storage module 342, and by the executing module 341, decrypting the designated data using the key of the data party, then executing a data processing instruction using the decrypted data, encrypting the processed target data using the key of the accessing party, obtaining a target data ciphertext, and sending the target data ciphertext to the request processing module 31, which sends the target data ciphertext to the accessing party.

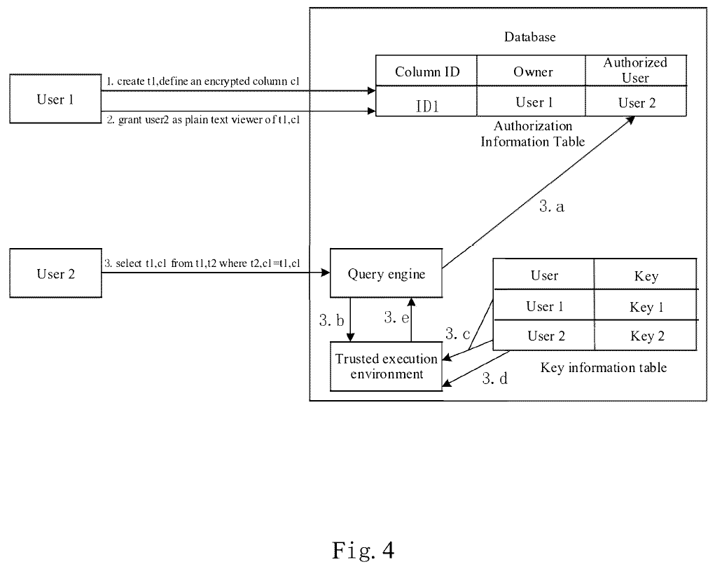

Referring to FIG. 4, a schematic diagram of another database according to embodiments of the present disclosure is shown. The database may store an authorization information table and a key information table. The interaction process of the database when making a data query may be as shown in FIG. 4. Interaction procedures may include:

1. User 1 may send a table building instruction like “create t1, define an encrypted column c1” to the database for building table t1 and defining the c1 column as an encrypted column.

2. User 1 may also send an authorization instruction, such as “grant user 2 as plain text viewer of t1, c1”, to the database for authorizing user 2 as an authorized user for column c1 in table t1. The database may update the authorization information table based on the table building instruction and authorization instruction from the user 1.

3. User 2 may send a query instruction to the server, such as “select t1,c1 from t1,t2 where t2,c1=t1,c1”, for querying the data in column c1 of table t1 for the same data as column c1 of table t2. Interaction procedures of the query engine of the database, upon receiving the query instruction of user 2, may include:

3.a. Querying from the authorization information table whether user 2 is authorized to access t2, c1 and t1, c1.

3.b. Upon querying that user 2 is an authorized user, the query instruction may be sent to the trusted execution environment.

3.c. The trusted execution environment may query the key of user 1 and the key of user 2 from the key information table, decrypt the corresponding matching data using the queried key data, and perform a data query.

3.d. Encrypting query results with the key of user 2.

3. e. Feeding back the encrypted query results to the query engine, which in turn returns the encrypted query results to user 2.

It will be appreciated by those skilled in the art that in the above-described methods of the detailed description, the order in which the steps are described does not imply a strict order of execution and constitutes any limitation on the implementation of the process, and that the particular order of execution of the steps should be determined by their functionality and possibly the underlying logic.

Based on the similar inventive concept, a database-based data processing apparatus corresponding to the database-based data processing method is further provided in the embodiments of the present disclosure, since the principle of solving the problem by the apparatus in the embodiments of the present disclosure is similar to the database-based data processing method described above in the embodiments of the present disclosure, the implementation of the apparatus can be referred to the implementation of the method, and the repetitions are not repeated.

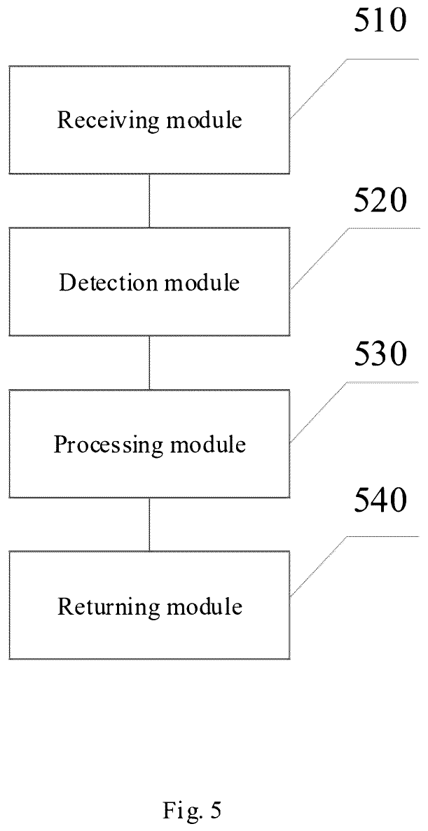

Referring to FIG. 5, it is a schematic diagram of a database-based data processing apparatus provided by embodiments of the present disclosure, the apparatus includes:
a receiving module 510, configured to receive a data processing request to a database, wherein the data processing request carries a user identification of an accessing party and a data processing instruction for indicating a processing of designated data to obtain target data;
a detection module 520, configured to, when the designated data is secret state data, query an authorization information table in the database based on the user identification of the accessing party to detect whether the accessing party is an authorized user of the designated data, wherein the secret state data refers to data stored by the database in decrypted form, and the authorization information table is used for recording authorized user information of the secret state data configured by a data party;
a processing module 530, configured to, when the accessing party is an authorized user of the designated data, decrypt the designated data based on a key of the data party in an isolated security environment and execute the data processing instruction based on decrypted data to obtain the target data, and encrypt the target data based on a key of the accessing party to obtain a target data ciphertext; and
a returning module 540, configured to return a response message carrying the target data ciphertext in response to the data processing request.

In an alternative implementation, the apparatus further includes a configuration module, configured to:
receive an authorization configuration instruction sent by the data party, wherein the authorization configuration instruction carries a user identification of the data party, a data identification of the designated data, and user identifications of authorized users, and the authorization configuration instruction is used to instruct configuring that the authorized users are authorized to access to the designated data; and
record a correspondence of the user identification of the data party, the data identification of the designated data, and the user identifications of the authorized users in the authorization information table in response to the authorization configuration instruction.

In an alternative implementation, the authorization configuration instruction further includes: an authorization access time limit, and the authorization information table records the correspondence of the user identification of the data party, the data identification of the designated data, and the user identifications of the authorized users and corresponding authorized access time limit, wherein the authorized access time limit is used to limit access time of the authorized users to the designated data.

In an alternative implementation, the apparatus further includes a deleting module, configured to:
receive an authorization deletion instruction sent by the data party, wherein the authorization deletion instruction carries a user identification of the data party, a data identification of the designated data, and user identifications of authorized users, and wherein the authorization deletion instruction is used to instruct deletion of configuration information that the authorized users are authorized to access to the designated data; and
delete a correspondence of the user identification of the data party, the data identification of the designated data, and the user identifications of the authorized users in the authorization information table in response to the authorization deletion instruction.

In an alternative implementation, designated data of the data party in the authorization information table is configured with user identifications of a plurality of authorized users.

In an alternative implementation, the authorization information table is dynamically updated with authorization configuration instructions sent by the data party.

In an alternative implementation, the designated data includes at least one column of secret state data in at least one data table corresponding to a designated column identification; or

the designated data includes at least one row of secret state data in at least one data table corresponding to a designated row identification; or

the designated data includes at least one secret state data element in at least one data table corresponding to a designated column identification and a designated row identification.

In an alternative implementation, the database is deployed in a trusted execution environment.

In an alternative implementation, the database is deployed in a trusted execution environment based on trusted hardware.

In an alternative implementation, the data processing instruction is used to instruct the processing of the designated data to obtain the target data, wherein the designated data includes first designated data of the accessing party and second designated data of the data party, and the first designated data and the second designated data are both secret state data;

wherein the apparatus is configured to:
query the authorization information table in the database based on the user identification of the accessing party, and detect whether the accessing party is an authorized user of the second designated data; when the accessing party is an authorized user of the second designated data, decrypt the second designated data in the isolated security environment based on the key of the data party to obtain second decrypted data, and decrypt the first designated data based on the key of the accessing party to obtain first decrypted data; execute the data processing instruction based on the first decrypted data and the second decrypted data to obtain the target data, and encrypt the target data based on the key of the accessing party to obtain the target data ciphertext.

The description of the process flow of the respective modules in the apparatus, and the interaction flow between the respective modules can refer to the related description in the above method embodiments, which will not be detailed here.

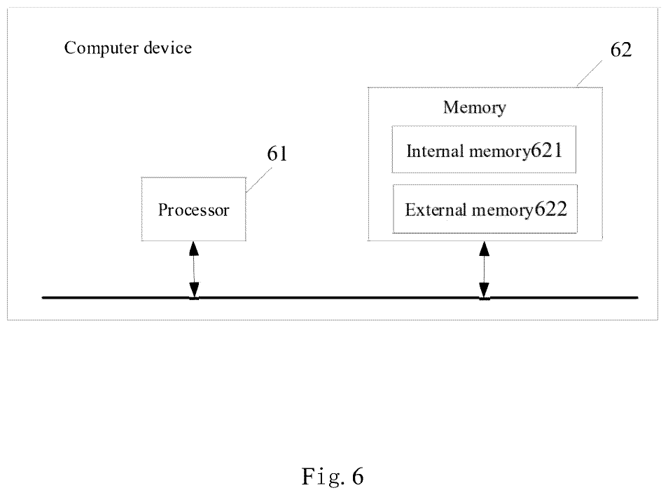

The embodiments of the present disclosure further provide a computer device, as shown in FIG. 6, which shows a schematic diagram of the computer device provided by the embodiments of the present disclosure, the computer device includes:

a processor 61 and a memory 62 (for example, a non-transitory memory). The memory 62 stores machine-readable instructions executable by the processor 61. The processor 61 is configured to execute the machine-readable instructions stored in the memory 62. The machine-readable instructions, when executed by the processor 61, cause the processor 61 to perform the steps of:
receiving a data processing request to a database, wherein the data processing request carries a user identification of an accessing party and a data processing instruction for indicating a processing of designated data to obtain target data;
when the designated data is secret state data, querying an authorization information table in the database based on the user identification of the accessing party to detect whether the accessing party is an authorized user of the designated data, wherein the secret state data refers to data stored by the database in decrypted form, and the authorization information table is used for recording authorized user information of the secret state data configured by a data party;
when the accessing party is an authorized user of the designated data, decrypting the designated data based on a key of the data party in an isolated security environment and executing the data processing instruction based on decrypted data to obtain the target data, and encrypting the target data based on a key of the accessing party to obtain a target data ciphertext; and
returning a response message carrying the target data ciphertext in response to the data processing request.

The memory 62 includes an internal memory 621 and an external memory 622. The internal memory 621 is also referred to as an internal storage and is used to temporarily store arithmetic data of the processor 61 and data exchanged with the external memory 622 such as a hard disk. The processor 61 exchanges data with the external memory 622 through the internal memory 621.

The specific execution process of the above instructions may refer to the steps of the database-based data processing method described in the embodiments of the present disclosure, which are not repeated here.

Embodiments of the present disclosure further provide a computer-readable storage medium having a computer program stored thereon. The computer program, when executed by a processor, causes the processor to execute the steps of the database-based data processing method described in the above method embodiments. The storage medium may be a transitory or non-transitory computer readable storage medium.

Embodiments of the present disclosure further provide a computer program product carrying program code. The program code includes instructions for executing the steps of the database-based data processing method described in the above method embodiments, which can be specifically referred to in the above method embodiments, and which are not described in detail here.

Therein, the above-mentioned computer program product may be specifically implemented by means of hardware, software, or a combination thereof. In an alternative implementation, the computer program product is embodied as a computer storage medium, and in another alternative implementation, the computer program product is embodied as a software product, such as a Software Development Kit (SDK) or the like.

It can be clearly understood by those skilled in the art that, for convenience and conciseness of description, the specific working processes of the above-described apparatus and device can be referred to the corresponding processes in the foregoing method embodiments, which are not repeated here. In the embodiments provided by the present disclosure, it is to be understood that the disclosed systems, devices, and methods may be implemented in other ways. The apparatus embodiments described above are merely illustrative, for example, the division of the modules (or units, circuits and so on) is merely one logical function, and other divisions may be actually implemented, for example, multiple units or components may be combined or integrated into another system, or some features may be omitted or not performed. Further, the coupling or direct coupling or communication connection between each other shown or discussed may be an indirect coupling or communication connection through some communication interface, device or unit, which may be electrical, mechanical or otherwise.

The elements illustrated as separate elements may or may not be physically separate, and the elements shown as elements may or may not be physical elements, i.e. may be located at one place, or may be distributed over a plurality of network elements. Some or all of the elements may be selected according to actual needs to achieve the purpose of the present disclosure.

In addition, each functional unit (or circuit) in each embodiment of the present disclosure may be integrated in one processing unit, each unit may be physically present separately, and two or more units may be integrated in one unit.

The functions, if implemented in the form of a software functional unit and sold or used as a stand-alone product, may be stored in a processor-executable non-volatile computer-readable storage medium. Based on such an understanding, the technical solution of the present disclosure in essence or the part contributing to the prior art or the part of the technical solution may be embodied in the form of a software product, which is stored in a storage medium, and includes a plurality of instructions for causing a computer device (which may be a personal computer, a server, or a network device, etc.) to perform all or a part of the steps of the methods of the various embodiments of the present disclosure. The aforementioned storage media include various media that can store program codes, such as a compact disk, a removable hard disk, a Read-Only Memory (ROM), a Random Access Memory (RAM), a magnetic disk, or an optical disk.

Finally, it should be noted that the above embodiments, which are only specific embodiments of the present disclosure, serve to illustrate the technical solutions of the present disclosure rather than to limit the same, and the scope of protection of the present disclosure is not limited thereto. Although the present disclosure has been described in detail with reference to the foregoing embodiments, those skilled in the art will appreciate that any person skilled in the art may modify the technical solutions described in the foregoing embodiments or may easily conceive of variations or may substitute equivalents to some of the technical features thereof within the technical scope of the present disclosure. While these modifications, variations or replacements, which do not make the essence of the corresponding technical solutions depart from the spirit and scope of the technical solutions of the embodiments of the present disclosure, shall be covered within the protection scope of the present disclosure. Therefore, the protection scope of the present disclosure should be subject to the protection scope of the claims.

What is claimed is:

1. A database-based data processing method, comprising:
receiving a data processing request to a database, wherein the data processing request carries a user identification of an accessing party and a data processing instruction for indicating a processing of designated data to obtain target data;
when the designated data is secret state data, querying an authorization information table in the database based on the user identification of the accessing party to detect whether the accessing party is an authorized user of the designated data, wherein the secret state data refers to data stored by the database in decrypted form, and the authorization information table is used for recording authorized user information of the secret state data configured by a data party;
when the accessing party is an authorized user of the designated data, decrypting the designated data based on a key of the data party in an isolated security environment and executing the data processing instruction based on decrypted data to obtain the target data, and encrypting the target data based on a key of the accessing party to obtain a target data ciphertext; and
returning a response message carrying the target data ciphertext in response to the data processing request.

2. The method of claim 1, further comprising:
receiving an authorization configuration instruction sent by the data party, wherein the authorization configuration instruction carries a user identification of the data party, a data identification of the designated data, and user identifications of authorized users, and the authorization configuration instruction is used to instruct configuring that the authorized users are authorized to access to the designated data; and
recording a correspondence of the user identification of the data party, the data identification of the designated data, and the user identifications of the authorized users in the authorization information table in response to the authorization configuration instruction.

3. The method of claim 2, wherein the authorization configuration instruction further comprises: an authorization access time limit, and the authorization information table records the correspondence of the user identification of the data party, the data identification of the designated data, and the user identifications of the authorized users and corresponding authorized access time limit, wherein the authorized access time limit is used to limit access time of the authorized users to the designated data.

4. The method of claim 1, further comprising:
receiving an authorization deletion instruction sent by the data party, wherein the authorization deletion instruction carries a user identification of the data party, a data identification of the designated data, and user identifications of authorized users, and wherein the authorization deletion instruction is used to instruct deletion of configuration information that the authorized users are authorized to access to the designated data; and
deleting a correspondence of the user identification of the data party, the data identification of the designated data, and the user identifications of the authorized users in the authorization information table in response to the authorization deletion instruction.

5. The method of claim 1, wherein designated data of the data party in the authorization information table is configured with user identifications of a plurality of authorized users.

6. The method of claim 1, wherein the authorization information table is dynamically updated with authorization configuration instructions sent by the data party.

7. The method of claim 1, wherein the designated data comprises at least one column of secret state data in at least one data table corresponding to a designated column identification; or
the designated data comprises at least one row of secret state data in at least one data table corresponding to a designated row identification; or
the designated data comprises at least one secret state data element in at least one data table corresponding to a designated column identification and a designated row identification.

8. The method of claim 1, wherein the database is deployed in a trusted execution environment.

9. The method of claim 1, wherein the database is deployed in a trusted execution environment based on trusted hardware.

10. The method of claim 1, wherein the data processing instruction is used to instruct the processing of the designated data to obtain the target data, wherein the designated data comprises first designated data of the accessing party and second designated data of the data party, and the first designated data and the second designated data are both secret state data;
wherein the target data ciphertext is obtained by:
querying the authorization information table in the database based on the user identification of the accessing party, and detecting whether the accessing party is an authorized user of the second designated data; when the accessing party is an authorized user of the second designated data, decrypting the second designated data in the isolated security environment based on the key of the data party to obtain second decrypted data, and decrypting the first designated data based on the key of the accessing party to obtain first decrypted data; executing the data processing instruction based on the first decrypted data and the second decrypted data to obtain the target data, and encrypting the target data based on the key of the accessing party to obtain the target data ciphertext.

11. A computer device comprising a processor and a non-transitory memory, wherein the non-transitory memory is configured to store machine-readable instructions executable by the processor, the processor is configured to execute the machine-readable instructions stored in the memory, wherein the machine-readable instructions, when executed by the processor, cause the processor to
receive a data processing request to a database, wherein the data processing request carries a user identification of an accessing party and a data processing instruction for indicating a processing of designated data to obtain target data;
when the designated data is secret state data, query an authorization information table in the database based on the user identification of the accessing party to detect whether the accessing party is an authorized user of the designated data, wherein the secret state data refers to data stored by the database in decrypted form, and the authorization information table is used for recording authorized user information of the secret state data configured by a data party;
when the accessing party is an authorized user of the designated data, decrypt the designated data based on a key of the data party in an isolated security environment and execute the data processing instruction based on decrypted data to obtain the target data, and encrypt the target data based on a key of the accessing party to obtain a target data ciphertext; and
return a response message carrying the target data ciphertext in response to the data processing request.

12. The computer device of claim 11, wherein the machine-readable instructions further cause the processor to: receive an authorization configuration instruction sent by the data party, wherein the authorization configuration instruction carries a user identification of the data party, a data identification of the designated data, and user identifications of authorized users, and the authorization configuration instruction is used to instruct configuring that the authorized users are authorized to access to the designated data; and
record a correspondence of the user identification of the data party, the data identification of the designated data, and the user identifications of the authorized users in the authorization information table in response to the authorization configuration instruction.

13. The computer device of claim 12, wherein the authorization configuration instruction further comprises: an authorization access time limit, and the authorization information table records the correspondence of the user identification of the data party, the data identification of the designated data, and the user identifications of the authorized users and corresponding authorized access time limit, wherein the authorized access time limit is used to limit access time of the authorized users to the designated data.

14. The computer device of claim 11, wherein the machine-readable instructions further cause the processor to:
receive an authorization deletion instruction sent by the data party, wherein the authorization deletion instruction carries a user identification of the data party, a data identification of the designated data, and user identifications of authorized users, and wherein the authorization deletion instruction is used to instruct deletion of configuration information that the authorized users are authorized to access to the designated data; and
delete a correspondence of the user identification of the data party, the data identification of the designated data, and the user identifications of the authorized users in the authorization information table in response to the authorization deletion instruction.

15. The computer device of claim 11, wherein designated data of the data party in the authorization information table is configured with user identifications of a plurality of authorized users.

16. The computer device of claim 11, wherein the authorization information table is dynamically updated with authorization configuration instructions sent by the data party.

17. The computer device of claim 11, wherein the designated data comprises at least one column of secret state data in at least one data table corresponding to a designated column identification; or
the designated data comprises at least one row of secret state data in at least one data table corresponding to a designated row identification; or
the designated data comprises at least one secret state data element in at least one data table corresponding to a designated column identification and a designated row identification.

18. The computer device of claim 11, wherein the database is deployed in a trusted execution environment, and wherein the database is deployed in a trusted execution environment based on trusted hardware.

19. The computer device of claim 11, wherein the data processing instruction is used to instruct the processing of the designated data to obtain the target data, wherein the designated data comprises first designated data of the accessing party and second designated data of the data party, and the first designated data and the second designated data are both secret state data;
wherein the target data ciphertext is obtained by:
querying the authorization information table in the database based on the user identification of the accessing party, and detecting whether the accessing party is an authorized user of the second designated data; when the accessing party is an authorized user of the second designated data, decrypting the second designated data in the isolated security environment based on the key of the data party to obtain second decrypted data, and decrypting the first designated data based on the key of the accessing party to obtain first decrypted data; executing the data processing instruction based on the first decrypted data and the second decrypted data to obtain the target data, and encrypting the target data based on the key of the accessing party to obtain the target data ciphertext.

20. A non-transitory computer-readable storage medium storing instructions that cause at least a processor to:
receive a data processing request to a database, wherein the data processing request carries a user identification of an accessing party and a data processing instruction for indicating a processing of designated data to obtain target data;
when the designated data is secret state data, query an authorization information table in the database based on the user identification of the accessing party to detect whether the accessing party is an authorized user of the designated data, wherein the secret state data refers to data stored by the database in decrypted form, and the authorization information table is used for recording authorized user information of the secret state data configured by a data party;
when the accessing party is an authorized user of the designated data, decrypt the designated data based on a key of the data party in an isolated security environment and execute the data processing instruction based on decrypted data to obtain the target data, and encrypt the target data based on a key of the accessing party to obtain a target data ciphertext; and
return a response message carrying the target data ciphertext in response to the data processing request.
